(19) United States
(12) Patent Application Publication
(10) Pub. No.: US 2025/0341440 A1
(43) Pub. Date: Nov. 6, 2025

(54) PNEUMATIC SMOKE INJECTION DEVICE

(71) Applicant: Scott Malone, Seaforth (CA)

(72) Inventor: Scott Malone, Seaforth (CA)

(21) Appl. No.: 18/653,588

(22) Filed: May 2, 2024

(51) Int. Cl. G01M 3/22

(52) U.S. Cl. CPC G01M 3/227

(57) ABSTRACT

A pneumatic smoke injection device for identifying an air leak in a tire includes a housing that has an air inlet which can be coupled to a supply hose of source of compressed air. An air hose is coupled to and extends away from the housing. The air hose has an air coupler that can be attached to a valve stem of a vehicle tire to direct to compressed air into the vehicle tire when the air coupler is attached to the valve stem. A smoke unit is integrated into the housing and the smoke unit produces a brightly colored smoke when the smoke unit is turned on. The smoke unit releases the brightly colored smoke into the air hose thereby facilitating an air leak in the vehicle tire be visually identified by the brightly colored smoke flowing outwardly from the air leak.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to smoke injection devices and more particularly pertains to a new smoke injection device for injecting smoke into a vehicle tire to visually identify an air leak. The device includes a smoke unit that has an air inlet that can be attached to a supply hose of a source of compressed air and an air hose that can be attached to valve stem of a vehicle tire. The smoke unit produces a brightly colored smoke that is blown into the vehicle tire thereby facilitating the brightly colored smoke to flow through an air leak in the vehicle tire to visually identify the air leak.

### (2) Description of Related Art Including Information Disclosed Under 37 CFR 1.97 and 1.98

The prior art relates to smoke injection devices including a variety of tire leak detection devices that each at least includes a source of detectable pressurized gas that is introduced into a vehicle tire such that an air leak of the vehicle tire can be detected by the presence of the detectable pressurized gas and a tire leak detection device that includes an aerosol canister that is filled with a pigmented suspension and an air hose attached to the aerosol canister that can be attached to valve stem of a vehicle tire for introducing the pigmented suspension into the vehicle tire to visually identify an air leak in the vehicle tire. In no instance does the prior art disclose a smoke unit that includes a dye reservoir and a fluid heater which heats a dye in the dye reservoir into a brightly colored smoke and a pump for urging the smoke into a conduit that is fluidly coupled between a supply hose of a source of compressed air and a valve stem of a vehicle tire for introducing the brightly colored smoke into the vehicle tire for visually identifying an air leak in the vehicle tire.

### BRIEF SUMMARY OF THE INVENTION

An embodiment of the disclosure meets the needs presented above by generally comprising a housing that has an air inlet which can be coupled to a supply hose of source of compressed air. An air hose is coupled to and extends away from the housing. The air hose has an air coupler that can be attached to a valve stem of a vehicle tire to direct to compressed air into the vehicle tire when the air coupler is attached to the valve stem. A smoke unit is integrated into the housing and the smoke unit produces a brightly colored smoke when the smoke unit is turned on. The smoke unit releases the brightly colored smoke into the air hose thereby facilitating an air leak in the vehicle tire be visually identified by the brightly colored smoke flowing outwardly from the air leak.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a pneumatic smoke injection device according to an embodiment of the disclosure.

FIG. 2 is a bottom perspective view of an embodiment of the disclosure.

FIG. 3 is a back view of an embodiment of the disclosure.

FIG. 4 is a cross sectional view taken along line 4-4 of FIG. 3 of an embodiment of the disclosure.

FIG. 5 is a perspective in-use view of an embodiment of the disclosure showing a supply hose of a source of compressed air being attached to a housing.

FIG. 6 is a perspective in-use view of an embodiment of the disclosure showing a brightly colored smoke being introduced into a vehicle tire.

FIG. 7 is a perspective in-use view of an embodiment of the disclosure showing a brightly colored smoke escaping a vehicle tire via an air leak for visually identifying the air leak.

### DETAILED DESCRIPTION OF THE INVENTION

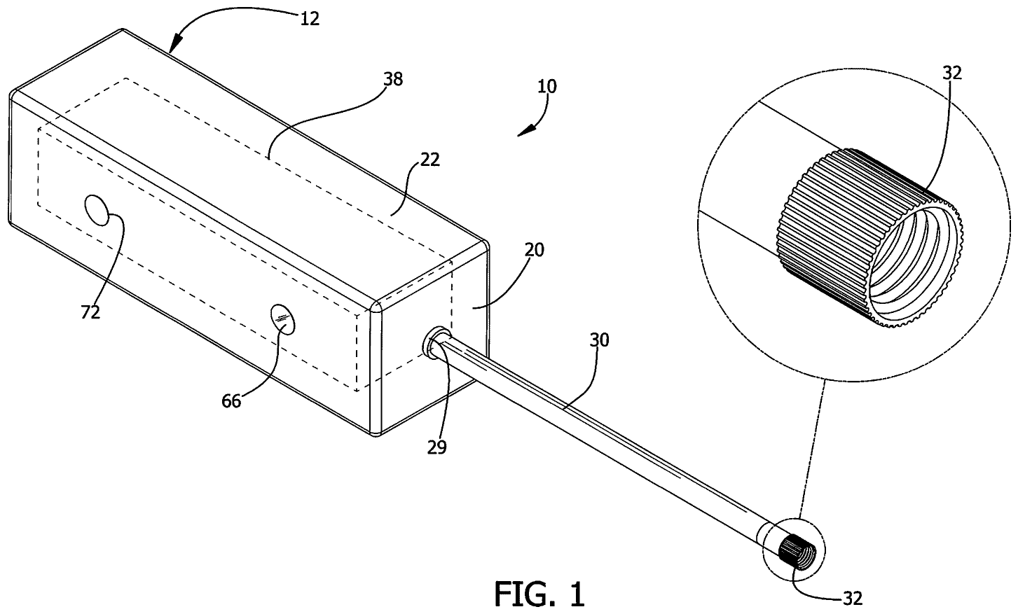

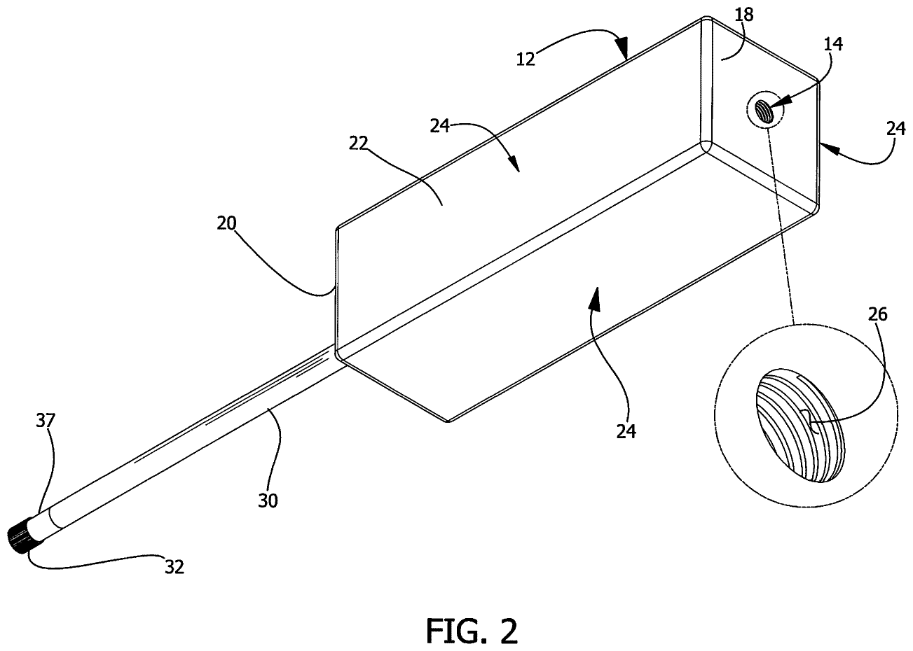

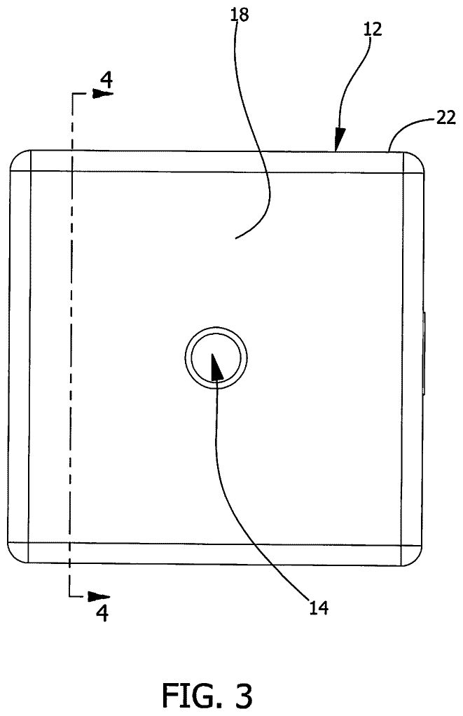

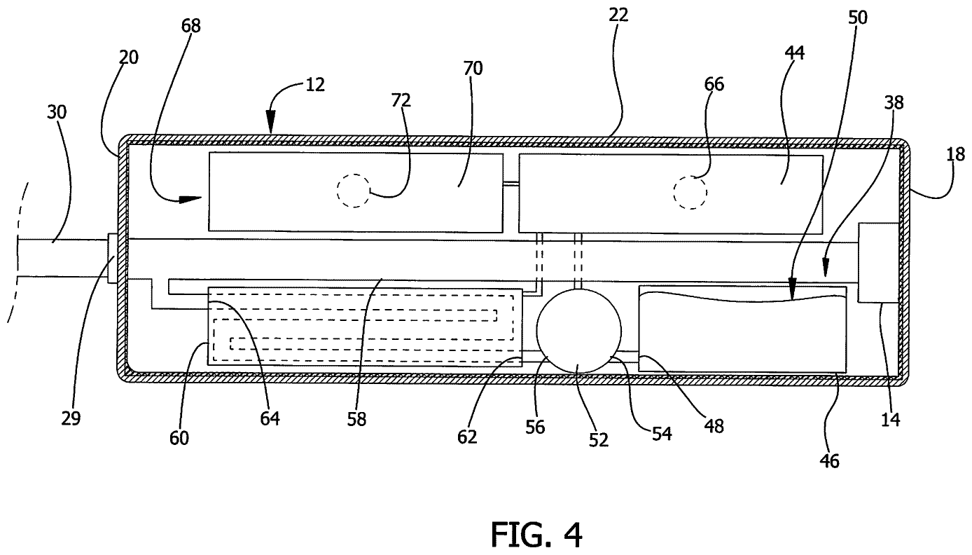

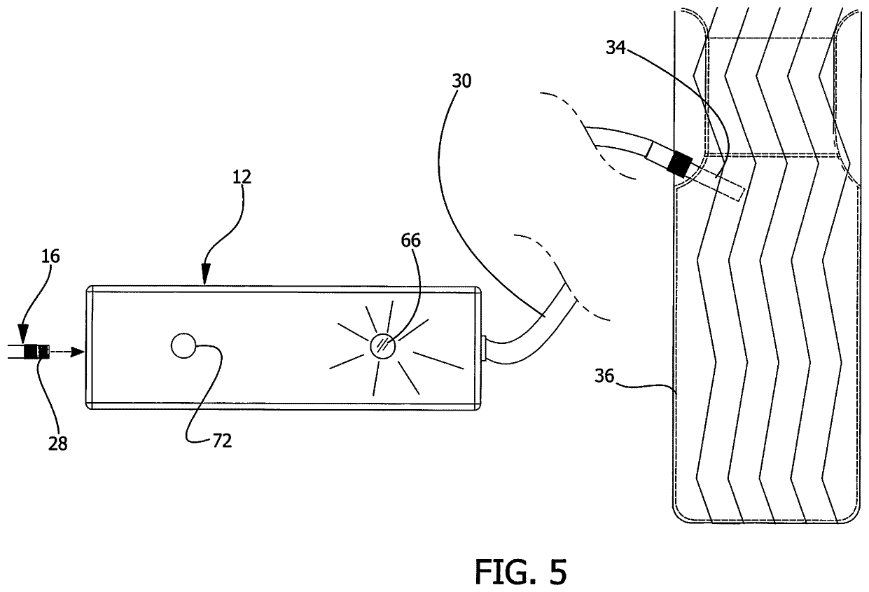

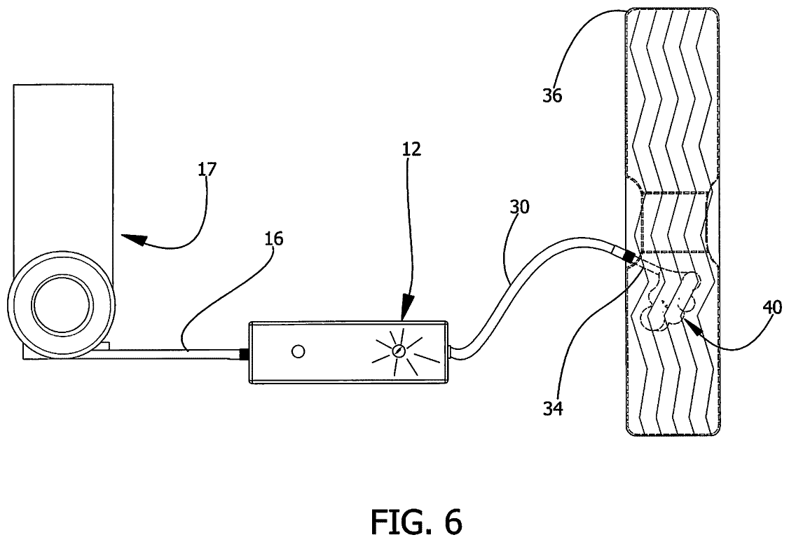

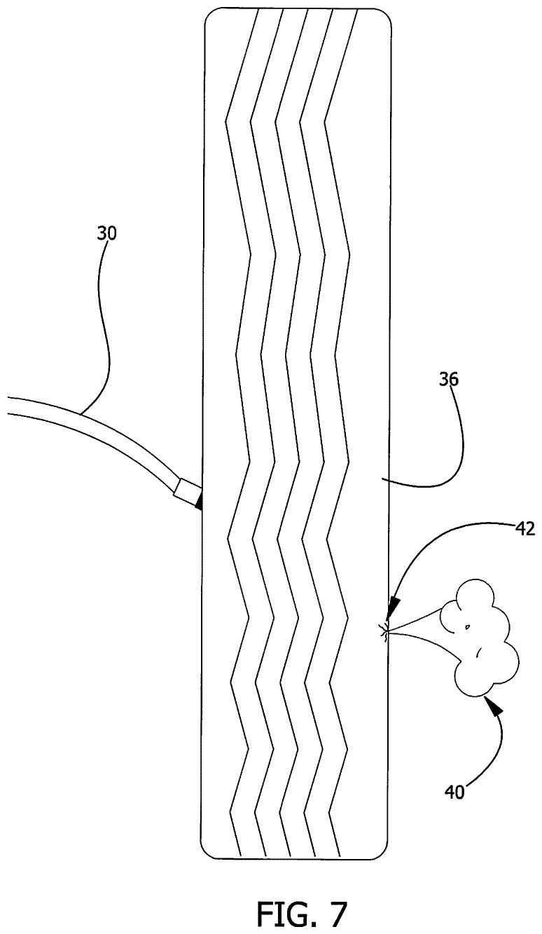

With reference now to the drawings, and in particular to FIGS. 1 through 7 thereof, a new smoke injection device embodying the principles and concepts of an embodiment of the disclosure and generally designated by the reference numeral 10 will be described.

As best illustrated in FIGS. 1 through 7, the pneumatic smoke injection device 10 generally comprises a housing 12 that has an air inlet 14 which can be fluidly coupled to a supply hose 16 of source of compressed air 17. The source of compressed air 17 may be an air compressor or an air tank the has previously been filled with compressed air or any other source of compressed air that is capable of inflating a vehicle tire. The housing 12 has a rear wall 18, a front wall 20 and an outer wall 22 extending between the rear wall 18 and the front wall 20 and the outer has a plurality of intersecting sides 24 that are perpendicularly oriented with each other such that the housing 12 has a cuboid shape.

The air inlet 14 is recessed into the rear wall 18 and the air inlet 14 has a bounding surface 26. The bounding surface 26 is threaded to facilitate a coupler 28 on the supply hose 16 to threadably engage the bounding surface 26 for securing the supply hose 16 in the air inlet 14. The coupler 28 on the supply hose 16 may comprise a 0.25 inch male air compressor fitting of any conventional design. Additionally, the housing 12 has an air outlet 29 that is recessed into the front wall 20.

An air hose 30 is coupled to and extends away from the housing 12 and the air hose 30 has an air coupler 32 which can be attached to a valve stem 34 of a vehicle tire 36. The vehicle tire 36 may be a tubeless tire of any conventional design that is commonly employed on motorized vehicles, including but not being limited to passenger vehicles or cargo vehicles or off road vehicles. Furthermore, the valve stem 34 may be a spring loaded air valve that is commonly employed on inflatable tires for inflating or deflating the inflatable tire. Additionally, the air hose 30 is in communication with the air inlet 14 to direct to compressed air into the vehicle tire 36 when the air coupler 32 on the air hose 30 is attached to the valve stem 34. The air hose 30 is fluidly coupled to the air outlet 29 in the front wall 20 of the housing 12 and the air coupler 32 on the air hose 30 is disposed on a distal end 37 of the air hose 30 with respect to the front wall 20 of the housing 12. The air coupler 32 on the air hose 30 may comprise a female air coupler 32 that is specifically designed to be compatible with valve stems of inflatable tires.

A smoke unit 38 is integrated into the housing 12 and the smoke unit 38 produces a brightly colored smoke 40 when the smoke unit 38 is turned on. The smoke unit 38 is in communication with the air hose 30 thereby facilitating the air hose 30 to release the brightly colored smoke 40 when the smoke unit 38 is turned on. In this way the air hose 30 can direct the brightly colored smoke 40 into the vehicle tire 36 when the air coupler 32 is coupled to the valve stem 34 of the vehicle tire 36. Thus, an air leak 42 in the vehicle tire 36 can be visually identified by the brightly colored smoke 40 flowing outwardly from the air leak without requiring the vehicle tire 36 to be removed from the vehicle and otherwise inspected for leaks.

The smoke unit 38 comprises a processor 44 that is integrated into the housing 12 and the processor 44 receives an actuate input. The smoke unit 38 includes a dye reservoir 46 that is integrated into the housing 12 and the dye reservoir 46 has an outlet 48. The dye reservoir 46 contains a fluid dye 50 and the fluid dye 50 comprises a thermally reactive dye that is commonly employed in fog machines for producing fog for theatrical and ornamental purposes.

The smoke unit 38 includes a pump 52 that is integrated into the housing 12; the pump 52 is electrically coupled to the processor 44 and the pump 52 is turned on when the processor 44 receives the actuate input. The pump 52 has an input 54 and an output 56; the input 54 is fluidly coupled to the outlet 48 of the dye reservoir 46 and the pump 52 urges the fluid dye 50 outwardly through the output when the pump 52 is turned on. The pump 52 may comprise an electric fluid pump or the like similar to that which is commonly employed in fog machines. The smoke unit 38 includes a conduit 58 that is positioned within the housing 12 and the conduit 58 is fluidly coupled between the air inlet 14 in the rear wall 18 of the housing 12 the air outlet 29 in the front wall 20 of the housing 12.

The smoke unit 38 includes a fluid heater 60 is integrated into the housing 12 and the fluid heater 60 is electrically coupled to the processor 44. The fluid heater 60 is turned on when the processor 44 receives the actuate input and the fluid heater 60 produces heat when the fluid heater 60 is turned on. The fluid heater 60 has an inlet 62 that is fluidly coupled to the outlet of the pump 52 such that the fluid heater 60 receives the fluid dye 50 when the pump 52 is turned on. The fluid heater 60 heats the fluid dye 50 when the fluid heater 60 is turned on such that the fluid dye 50 is converted into a brightly colored smoke 40. Additionally, the fluid heater 60 has an outlet 64 that is fluidly coupled to the conduit 58 such that the conduit 58 receives the brightly colored smoke 40 thereby facilitating the brightly colored smoke 40 to be urged outwardly through the air hose 30. The fluid heater 60 may comprise a heat exchanger that has an electric heating coil integrated into the heat exchanger which has an operational temperature sufficient to volatilize the fluid dye 50 into the brightly colored smoke 40.

A light 66 is integrated into the outer wall 22 of the housing 12 to emit light outwardly from the housing 12. The light 66 is electrically coupled to the processor 44 and the light 66 is turned on when the pump 52 and the fluid heater 60 are turned on. In this way the light 66 can visually communicate that the pump 52 and the fluid heater 60 are turned on. Furthermore, the light 66 may comprise a light emitting diode or other type of electronic light emitter.

A power supply 68 is integrated into the housing 12 and the power supply 68 is electrically coupled to the processor 44. The power supply 68 comprises at least one battery 70 that is integrated into the housing 12 and the at least one battery 70 is electrically coupled to the processor 44. The power supply 68 includes a power button 72 that is movably integrated into the outer wall 22 of the housing 12. The power button 72 is electrically coupled to the processor 44; the power button 72 turns the processor 44 on and off and the processor 44 receives the actuate input when the processor 44 is turned on.

In use, the air hose 30 for the source of compressed air 17 is attached to the air inlet 14 in the housing 12 and the coupler on air hose 30 which is attached to the air outlet 29 of the housing 12 is coupled to the valve stem 34 on the vehicle tire 36. The power button 72 is manipulated to actuate the pump 52 and the fluid heater 60 and the source of compressed air 17 is turned on the urge compressed air into the vehicle tire 36. Furthermore, the brightly colored smoke 40 produced by the fluid heater 60 is introduced into the compressed air such that the brightly colored smoke 40 is urged into the vehicle tire 36. In this way the brightly colored smoke 40 will flow outwardly through a puncture or other type of air leak in the vehicle tire 36 thereby facilitating the puncture or other type of air leak to be quickly visually identified for repair.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pneumatic smoke injection device for injecting a brightly colored smoke into a vehicle tire for visually identifying an air leak in the vehicle tire, said device comprising:
a housing having an air inlet wherein said air inlet is configured to be coupled to a supply hose of source of compressed air;
an air hose being coupled to and extending away from said housing, said air hose having an air coupler wherein said coupler is configured to be attached to a valve stem of a vehicle tire, said air hose being in communication with said air inlet wherein said air hose is configured to direct to compressed air into the vehicle tire when said air coupler is attached to the valve stem; and
a smoke unit being integrated into said housing, said smoke unit producing a brightly colored smoke when said smoke unit is turned on, said smoke unit being in communication with said air hose thereby facilitating said air hose to release said brightly colored smoke when said smoke unit is turned on wherein said air hose is configured to direct the brightly colored smoke into the vehicle tire when said air coupler is coupled to the valve stem of the vehicle tire thereby facilitating an air leak in the vehicle tire be visually identified by the brightly colored smoke flowing outwardly from the air leak.

2. The device according to claim 1, wherein:
said housing has a rear wall, a front wall and an outer wall extending between said rear wall and said front wall;
said outer has a plurality of intersecting side being perpendicularly oriented with each other such that said housing has a cuboid shape;
said air inlet is recessed into said rear wall;
said air inlet has a bounding surface, said bounding surface being threaded wherein said bounding surface is configured to threadably engage a coupler on the air hose for securing the air hose in said air inlet;
said housing has an air outlet being recessed into said front wall; and
said air hose is fluidly coupled to said air outlet in said front wall of said housing, said air coupler being disposed on a distal end of said air hose with respect to said front wall of said housing.

3. The device according to claim 1, wherein said smoke unit comprises:
a processor being integrated into said housing, said processor receiving an actuate input;
a dye reservoir being integrated into said housing, said dye reservoir containing a fluid dye, said fluid dye comprising a thermally reactive dye, said dye reservoir having an outlet; and
a pump being integrated into said housing, said pump being electrically coupled to said processor, said pump being turned on when said processor receives said actuate input, said pump having an input and an output, said input being fluidly coupled to said outlet of said fluid reservoir, said pump urging said fluid dye outwardly through said output when said pump is turned on.

4. The device according to claim 4, wherein:
said housing has an air inlet being recessed into a rear wall of said housing, said housing having an air outlet being recessed into a front wall of said housing; and
said smoke unit includes:
a conduit being positioned within said housing, said conduit being fluidly coupled between said air inlet in said rear wall of said housing said air outlet in said front wall of said housing; and
a fluid heater being integrated into said housing;
said fluid heater is electrically coupled to said processor;
said fluid heater is turned on when said processor receives said actuate input;
said fluid heater produces heat when said fluid heater is turned on;
said fluid heater has an inlet being fluidly coupled to said outlet of said pump such that said fluid heater receives said fluid dye when said pump is turned on;
said fluid heater heats said fluid dye when said fluid heater is turned on such that said fluid dye is converted into a brightly colored smoke; and
said fluid heater has an outlet being fluidly coupled to said conduit such that said conduit receives said brightly colored smoke thereby facilitating said brightly colored smoke to be urged outwardly through said air tube.

5. The device according to claim 4, wherein said smoke unit includes a light being integrated into said outer wall of said housing wherein said light is configured to emit light outwardly from said housing, said light being electrically coupled to said processor, said light being turned on when said pump and said fluid heater are turned on wherein said light is configured to visually communication that said pump and said fluid heater are turned on.

6. The device according to claim 3, wherein said smoke unit includes a power supply being integrated into said housing, said power supply being electrically coupled to said processor, said power supply comprising:
at least one battery being integrated into said housing, said at least one battery being electrically coupled to said processor; and
a power button being movably integrated into said outer wall of said housing, said power button being electrically coupled to said processor, said power button turning said processor on and off, said processor receiving said actuate input when said processor is turned on.

7. A pneumatic smoke injection device for injecting a brightly colored smoke into a vehicle tire for visually identifying an air leak in the vehicle tire, said device comprising:
a housing having an air inlet wherein said air inlet is configured to be coupled to an supply hose of source of compressed air, said housing having a rear wall, a front wall and an outer wall extending between said rear wall and said front wall, said outer having a plurality of intersecting side being perpendicularly oriented with each other such that said housing has a cuboid shape, said air inlet being recessed into said rear wall, said air inlet having a bounding surface, said bounding surface being threaded wherein said bounding surface is configured to threadably engage a coupler on the air hose for securing the air hose in said air inlet, said housing having an air outlet being recessed into said front wall;
an air hose being coupled to and extending away from said housing, said air hose having an air coupler wherein said coupler is configured to be attached to a valve stem of a vehicle tire, said air hose being in communication with said air inlet wherein said air hose is configured to direct to compressed air into the vehicle tire when said air coupler is attached to the valve stem, said air hose being fluidly coupled to said air outlet in said front wall of said housing, said air coupler being disposed on a distal end of said air hose with respect to said front wall of said housing;
a smoke unit being integrated into said housing, said smoke unit producing a brightly colored smoke when said smoke unit is turned on, said smoke unit being in communication with said air hose thereby facilitating said air hose to release said brightly colored smoke when said smoke unit is turned on wherein said air hose is configured to direct the brightly colored smoke into the vehicle tire when said air coupler is coupled to the valve stem of the vehicle tire thereby facilitating an air leak in the vehicle tire be visually identified by the brightly colored smoke flowing outwardly from the air leak, said smoke unit comprising:
a processor being integrated into said housing, said processor receiving an actuate input;
a dye reservoir being integrated into said housing, said dye reservoir containing a fluid dye, said fluid dye comprising a thermally reactive dye, said dye reservoir having an outlet;
a pump being integrated into said housing, said pump being electrically coupled to said processor, said pump being turned on when said processor receives said actuate input, said pump having an input and an output, said input being fluidly coupled to said outlet of said fluid reservoir, said pump urging said fluid dye outwardly through said output when said pump is turned on;
a conduit being positioned within said housing, said conduit being fluidly coupled between said air inlet in said rear wall of said housing said air outlet in said front wall of said housing;
a fluid heater being integrated into said housing, said fluid heater being electrically coupled to said processor, said fluid heater being turned on when said processor receives said actuate input, said fluid heater producing heat when said fluid heater is turned on, said fluid heater having an inlet being fluidly coupled to said outlet of said pump such that said fluid heater receives said fluid dye when said pump is turned on, said fluid heater heating said fluid dye when said fluid heater is turned on such that said fluid dye is converted into a brightly colored smoke, said fluid heater having an outlet being fluidly coupled to said conduit such that said conduit receives said brightly colored smoke thereby facilitating said brightly colored smoke to be urged outwardly through said air tube;
a light being integrated into said outer wall of said housing wherein said light is configured to emit light outwardly from said housing, said light being electrically coupled to said processor, said light being turned on when said pump and said fluid heater are turned on wherein said light is configured to visually communication that said pump and said fluid heater are turned on; and
a power supply being integrated into said housing, said power supply being electrically coupled to said processor, said power supply comprising:
at least one battery being integrated into said housing, said at least one battery being electrically coupled to said processor; and
a power button being movably integrated into said outer wall of said housing, said power button being electrically coupled to said processor, said power button turning said processor on and off, said processor receiving said actuate input when said processor is turned on.
